(19) United States
(12) Patent Application Publication
(10) Pub. No.: US 2014/0298240 A1
(43) Pub. Date: Oct. 2, 2014

(54) MEGA LENS STYLE TAB MANAGEMENT

(71) Applicants: John Nicholas JITKOFF, Palo Alto, CA (US); Scott R. Violet, Sunnyvale, CA (US); Peter Kasting, San Jose, CA (US)

(72) Inventors: John Nicholas JITKOFF, Palo Alto, CA (US); Scott R. Violet, Sunnyvale, CA (US); Peter Kasting, San Jose, CA (US)

(73) Assignee: GOOGLE INC., Mountain View, CA (US)

(21) Appl. No.: 13/406,460

(22) Filed: Feb. 27, 2012

Related U.S. Application Data
(60) Provisional application No. 61/496,970, filed on Jun. 14, 2011.

(51) Int. Cl. G06F 3/048

(52) U.S. Cl. 715/777

(57) ABSTRACT

The subject matter of this specification can be implemented in, among other things, a computer-implemented method for managing tabs in a graphical user interface. The method includes receiving a first user input that selects a first tab from among a plurality of tabs in a tab area of a tabbed interface. The method further includes expanding a dimension of the first tab and each of a first subset of tabs, from among and including fewer than all of the plurality of tabs, around the first tab in response to receiving the first user input.

### CROSS-REFERENCE TO RELATED APPLICATIONS

This application claims the benefit of U.S. Provisional Application No. 61/496,970, filed on Jun. 14, 2011, and entitled “Tab Overflow Management,” which is incorporated herein by reference.

### TECHNICAL FIELD

This instant specification relates to managing tabs in a graphical user interface.

### BACKGROUND

A tabbed document interface (TDI) allows multiple documents to be accessed from within a single graphical user interface (GUI). Anachronistically, the tabs in a TDI are based on physical tabs one would use in paper files or card indexes. Each TDI tab, typically aligned along a top edge of a GUI, allows a user to switch to a particular document or page in a set of documents or pages within the GUI. A TDI is commonly used in applications, such as web browsers, text editors, and configuration settings dialogs.

### SUMMARY

In one aspect, a computer-implemented method for managing tabs in a graphical user interface includes receiving a first user input that selects a first tab from among a plurality of tabs in a tab area of a tabbed interface. The method further includes expanding a dimension of the first tab and each of a first subset of tabs, from among and including fewer than all of the plurality of tabs, around the first tab in response to receiving the first user input.

Implementations can include any, all, or none of the following features. Expanding the dimension of the first tab and each of the first subset of tabs can include expanding the first tab and the first subset of tabs to encompass the tab area. The first user input can include a hover operation of a pointer provided by a pointing device. Expanding can include gradually expanding the dimension of the first tab and each of the first subset of tabs based on a distance between the first tab and the pointer. At least a portion of the first tab can remain under a position of the pointer after expanding the dimension of the first tab. The method can include receiving a second user input that selects a second tab from among the first tab and the first subset of tabs after receiving the first user input. The pointer can remain in the tab area between receiving the first user input and receiving the second user input. The second user input can include the hover operation. The method can include determining that the second user input occurs for at least a threshold amount of time. The method can include expanding the dimension of the second tab and each of a second subset of tabs, from among and including fewer than all of the first tab and the first subset of tabs, around the second tab again in response to determining that the second user input occurs for at least the threshold amount of time. The method can include receiving a third user input that moves the pointer out of the tab area. The method can include returning the dimension of each of the plurality of tabs to an unexpanded size in response to receiving the third user input. The method can include receiving a fourth user input that selects a third tab from among the plurality of tabs after receiving the third user input. The third user input can include the hover operation. The method can include expanding the dimension of the third tab and each of a third subset of tabs, from among and including fewer than all of the plurality of tabs, around the third tab in response to receiving the third user input. At least a portion of the first tab and each of the first subset of tabs can be displayed in the tab area after expanding the dimension of the first tab and each of the first subset of tabs. The plurality of tabs can be arranged horizontally. The method can include sliding one or more of the first tab and the first subset of tabs horizontally to accommodate expanding the dimension of the first tab and each of the first subset of tabs. The horizontally arranged plurality of tabs can be further arranged in an ordered list. One or more of the first subset of tabs can occur before the first tab in the ordered list and one or more of the first subset of tabs occur after the first tab in the ordered list. The method can include receiving a fifth user input that activates the first tab. The fifth user input can be separate from and of a different type than the first user input. The method can include activating a panel associated with the first tab in response to receiving the fifth user input.

In one aspect, a computer-readable medium storing instructions that when executed cause a computer to perform operations for managing tabs in a graphical user interface. The operations include receiving a first user input that selects a first tab from among a plurality of tabs in a tab area of a tabbed interface. The operations further include expanding a dimension of the first tab and each of a first subset of tabs, from among and including fewer than all of the plurality of tabs, around the first tab in response to receiving the first user input.

Implementations can include any, all, or none of the following features. Expanding the dimension of the first tab and each of the first subset of tabs can include expanding the first tab and the first subset of tabs to encompass the tab area. The first user input can include a hover operation of a pointer provided by a pointing device. Expanding can include gradually expanding the dimension of the first tab and each of the first subset of tabs based on a distance between the first tab and the pointer. At least a portion of the first tab can remain under a position of the pointer after expanding the dimension of the first tab. The operations can include receiving a second user input that selects a second tab from among the first tab and the first subset of tabs after receiving the first user input. The pointer can remain in the tab area between receiving the first user input and receiving the second user input. The second user input can include the hover operation. The operations can include determining that the second user input occurs for at least a threshold amount of time. The operations can include expanding the dimension of the second tab and each of a second subset of tabs, from among and including fewer than all of the first tab and the first subset of tabs, around the second tab again in response to determining that the second user input occurs for at least the threshold amount of time. The operations can include receiving a third user input that moves the pointer out of the tab area. The operations can include returning the dimension of each of the plurality of tabs to an unexpanded size in response to receiving the third user input. The operations can include receiving a fourth user input that selects a third tab from among the plurality of tabs after receiving the third user input. The third user input can include the hover operation. The operations can include expanding the dimension of the third tab and each of a third subset of tabs, from among and including fewer than all of the plurality of tabs, around the third tab in response to receiving the third user input. At least a portion of the second tab and each of the second subset of tabs can be displayed in the tab area after expanding the dimension of the second tab and each of the second subset of tabs. The plurality of tabs can be arranged horizontally. The operations can include sliding one or more of the second tab and the second subset of tabs horizontally to accommodate expanding the dimension of the second tab and each of the second subset of tabs. The horizontally arranged plurality of tabs can be further arranged in an ordered list. One or more of the second subset of tabs can occur before the second tab in the ordered list and one or more of the second subset of tabs occur after the second tab in the ordered list. The operations can include receiving a fifth user input that activates the first tab. The fifth user input can be separate from and of a different type than the first user input. The operations can include activating a panel associated with the first tab in response to receiving the fifth user input.

In one aspect, a computer-implemented system for managing tabs in a graphical user interface includes a display device that presents a plurality of tabs in a tab area of a tabbed interface. The system further includes an interface that receives a first user input that selects a first tab from among the plurality of tabs. The system further includes one or more processors that expand a dimension of the first tab and each of a first subset of tabs, from among and including fewer than all of the plurality of tabs, around the first tab in response to receiving the first user input.

The details of one or more implementations are set forth in the accompanying drawings and the description below. Other features and advantages will be apparent from the description and drawings, and from the claims.

### DESCRIPTION OF DRAWINGS

FIG. 1 is a schematic diagram that shows an example of a system for managing tabs in a graphical user interface.

FIGS. 2A-D show examples of graphical user interfaces for managing tabs in a graphical user interface using a mega lens style.

FIG. 3 is a flow chart that shows an example of a process for managing tabs in a graphical user interface using a mega lens style.

FIG. 4 is a schematic diagram that shows an example of a computing device and a mobile computing device.

### DETAILED DESCRIPTION

This document describes systems and techniques for managing tabs in a tabbed document interface (TDI) of a graphical user interface. As each document is opened, a tab is created for the document. A document can be, for example, a word processing file, spreadsheet file, text file, web page, or other working file in a TDI. A user input that activates a tab causes the TDI to present the document associated with the tab in a presentation area of the TDI. In some implementations, one or more of the tabs can include information about the document associated with the tab, such as a title of the document (e.g., a file name or a title of a web page) or a summary of content in the document (e.g., a particular number of unread emails). As more documents are opened the amount of space available to display an individual tab may be reduced. This may limit the amount of information a user can see about the tab.

The GUIs described with respect to the figures below can be, for example, applications running or being executed at a computing device, such as a desktop, laptop, tablet device, or mobile device. In some implementations, the GUIs may be accessed using input/output devices such as a pointing device (e.g., a mouse, track ball, touchpad, or touch display) and a keyboard (e.g., a physical keyboard or a soft keyboard). The applications can be, for example, web browsers and/or other applications where multiple documents or working files are currently open or referenced with the application.

The application and corresponding tabs may be implemented using multiple processes at the computing device. For example, each tab may be implemented in a separate process and together the tabs give the appearance of a single cohesive application to the user. Multiple methods can be used to manage tabs where the amount of space occupied by the tabs when fully expanded is larger than the screen space available for displaying the tabs. In general, the application can receive a user input that selects a tab or group of tabs for expansion. In response to receiving the user input, the application expands the selected tab or group of tabs, and reduces or collapses one or more other tabs that were not selected for expansion.

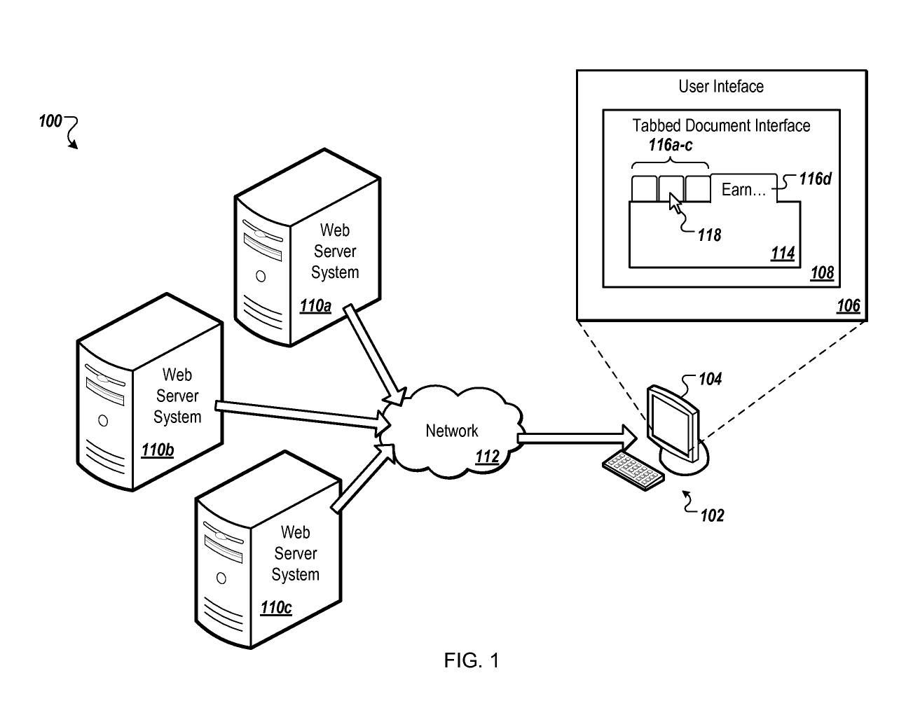

FIG. 1 is a schematic diagram that shows an example of a system 100 for managing tabs in a graphical user interface. The system 100 includes a computing device 102 that has a display device 104. The display device 104 presents a user interface 106 of one or more applications in operation at the computing device 102. The user interface 106 includes a tabbed document interface 108 for presenting multiple sets of information within the user interface 106.

For example, the tabbed document interface 108 can present multiple word processing documents in a user interface of a word processing application. In another example, the computing device 102 can receive multiple web pages from one or more web server systems 110a-c over a network 112. The tabbed document interface 108 can then present the multiple web pages in a user interface of a web browser application. In yet another example, the tabbed document interface 108 can present information other than documents, such as multiple sets of configuration settings in a configuration settings dialog window.

Each document, web page, or other item can be associated with one of multiple tabs 116a-d in the tabbed document interface 108. While shown here as including four tabs, the tabbed document interface 108 can include more or fewer tabs. In addition, over time tabs can be added to and/or removed from the tabbed document interface 108, for example, as a user makes inputs that open and/or close documents or pages.

A user can request presentation of a particular item in a presentation area 114 of the tabbed document interface 108 by making an input on the tab 116d associated with the item. The input on the tab 116d activates the item associated with the tab 116d in the presentation area 114. For example, a user can make an input with a pointing device on the tab 116d, such as a mouse click, that activates a document associated with the tab 116d in the presentation area 114. In another example, a user can make an input on the tab 116d using a keyboard or touch interface that activates the associated item in the presentation area 114.

In addition to activating an item, the tabbed document interface 108 can receive a user input that selects at least one of the tabs 116a-d for expansion, such as by hovering a pointer 118 over the selected tab or set of tabs. In some implementations, a user input (e.g., a mouse click) that activates an item associated with a tab also selects the tab for expansion.

A user input that requests expansion of a tab can include a passive input. For example, the passive input can include hovering the pointer 118 over the tab for a threshold amount of time. In some implementations, the tabbed document interface 108 expands the selected tab or set of tabs without activating an associated document or page in the presentation area 114, such as where the input is a passive input requesting expansion of the tab or set of tabs.

The user input requesting expansion of the tab or set of tabs can include an active input. For example, the active input can include clicking a button, tapping a touch surface, or pressing a key while the pointer 118 is over a tab or set of tabs. In some implementations, a user input that includes the active input makes the document associated with the selected tab or set of tabs active in the presentation area 114 in addition to expanding the selected tab or set of tabs.

The tabbed document interface 108 can expand the selected tab or set of tabs substantially in place. For example, the center of the selected tab or set of tabs may remain in the same position before and after the expansion. In another example, the space occupied by the selected tab or set of tabs before and after the expansion may overlap. Where the pointer 118 was used to select the tab or set of tabs, the tabbed document interface 108 can expand the selected tab or set of tabs so that the selected tab or set of tabs remains under the position of the pointer 118 after the expansion.

While examples described herein make reference to a pointer provided by a pointing device, other user input devices can be used. A user can, for example, make inputs using a keyboard, such as a first key combination to enter or begin selection of the tabs 116a-d, additional key presses to navigate through the tabs 116a-d (e.g., arrow keys), and a key press to activate a document associated with a tab or request expansion of a tab or set of tabs (e.g., an enter key). The tabbed document interface 108 can highlight the selected tab or set of tabs to indicate that the user has made one or more inputs using a device other than a pointing device to request activation of a document and/or expansion of a tab or set of tabs.

In expanding a tab or set of tabs, the tabbed document interface 108 expands a dimension of the tab or each tab in the set of tabs, such as a width and/or height of the tab. Each of the tabs 116a-d may have the same size when in an expanded state. For example, the dimension of each expanded tab can have a predetermined pixel width or percentage of the space available for the tabs 116a-d. In some implementations, the tabbed document interface 108 displays the change between a reduced state and an expanded state as an animation that gradually and/or smoothly transitions from one size of the dimension to the next.

Conversely, the tabbed document interface 108 can reduce or collapse a dimension of one or more tabs that were not selected for expansion. For example, the tabbed document interface 108 can distribute an amount of reduction across one or more tabs that were not selected that corresponds to an amount by which the selected tabs were expanded. In another example, the tabbed document interface 108 can expand the selected tabs to an expanded state and collapse the tabs that were not selected to a collapsed state.

In some implementations, the tabbed document interface 108 can include a user interface control for accessing a menu that lists each of the reduced and/or collapsed tabs. The tabbed document interface 108 can receive a user input that selects the user interface control. In response, the tabbed document interface 108 presents the menu including the list of reduced and/or collapsed tabs. The tabbed document interface 108 can then receive a user input that selects a reduced and/or collapsed tab from the list. In response, the tabbed document interface 108 can then activate the selected tab in the presentation area 114 and/or expand the dimension of the selected tab.

Each of the tabs 116a-d can include text, symbols, and/or icons that represent the associated items, such as a name of an associated document or web page, and/or an image for an associated document or web page. In some implementations, when expanding a tab or set of tabs, the tabbed document interface 108 expands the dimension of the tab or each tab in the set of tabs to accommodate the text, symbols, and/or icons included in the tab. For example, the tabbed document interface 108 can receive a user input requesting expansion of the tab 116d, and in response, expands the tab 116d so that it displays the full document title “Earnings Report” instead of the document title “Earn . . . ” that was truncated due to the reduced size of the tab 116d.

In addition, the tabbed document interface 108 may have a maximum size for the dimension. For example, the tabbed document interface 108 can limit the expansion of the dimension to a maximum number of characters, pixels, or other measurement of length for the text, symbols, and/or icons included in the tab. In another example, the tabbed document interface 108 can limit the expansion of the dimension to a relative amount, such as a percentage of the space available for the tabs 116a-d.

The dimension of one or more tabs may remain fixed (e.g., in a reduced state and/or an expanded state) while other tabs are expanded and/or reduced. For example, the fixed tabs can include a particular number of tabs, such as about ten tabs. The fixed tabs can be based on an analysis of the documents or pages accessed most by the user, with the most accessed being included in the set of fixed tabs. In some implementations, the user can make an input to explicitly request that one or more particular documents or pages be included in the set of fixed tabs (e.g., by “pinning” the tab to the set of fixed tabs).

The number of fixed tabs can be based on the amount of space available for the tabs 116a-d. For example, the fixed tabs may occupy a particular percentage of the space available, such as about 85% of the space available for the tabs 116a-d. The tabbed document interface 108 can place the fixed tabs on the left end or beginning of a list of the tabs 116a-d. Alternatively, the tabbed document interface 108 can leave each fixed tab at the position in which the tab was identified as fixed (e.g., by a user pinning input or by usage analysis).

In some implementations, the tabbed document interface 108 includes a fixed or limited amount of space for the tabs. As tabs are added, removed, and/or changed in size, the tabbed document interface 108 manages the use of the space that is available for the tabs 116a-d. The tabbed document interface 108 follows one or more rules to determine how to divide the available space up among the tabs for the items that are currently available for access within the tabbed document interface 108. The rules can include, for example, a mega lens style, that expands a dimension of at least one tab and one or more tabs around the tab.

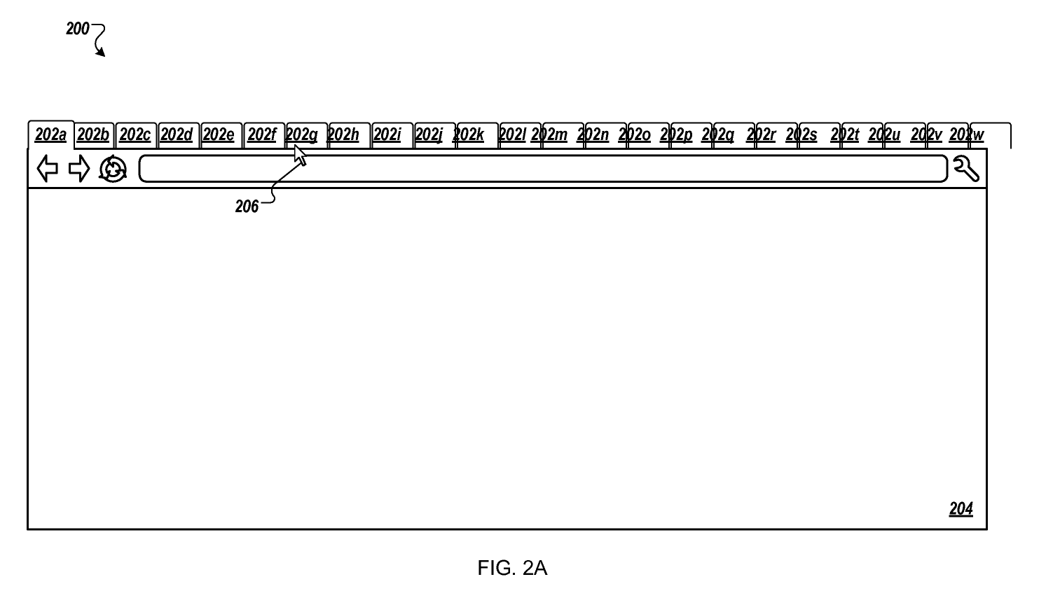

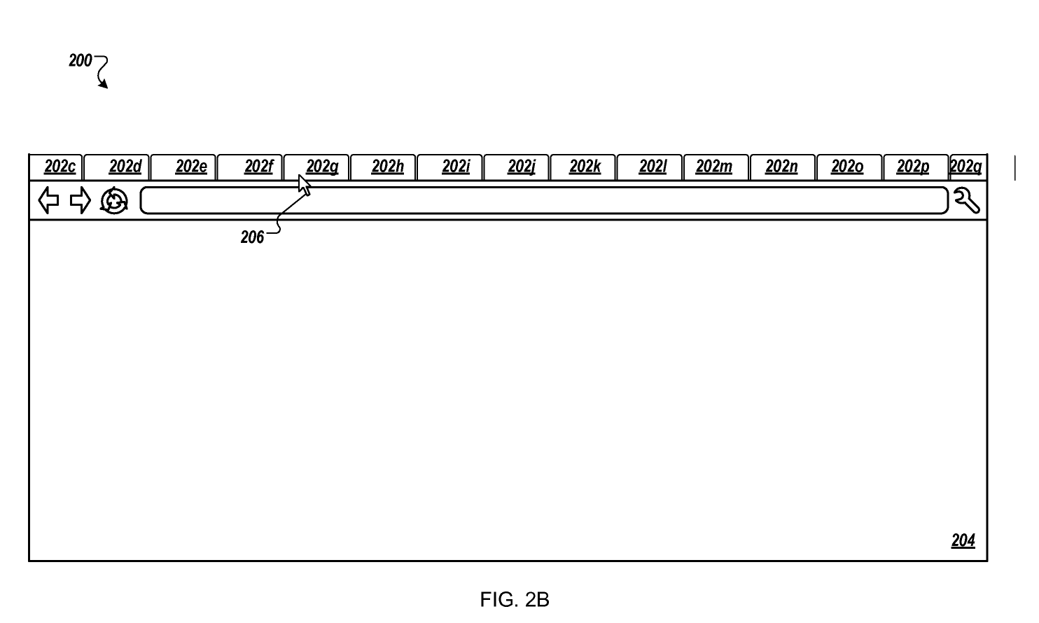

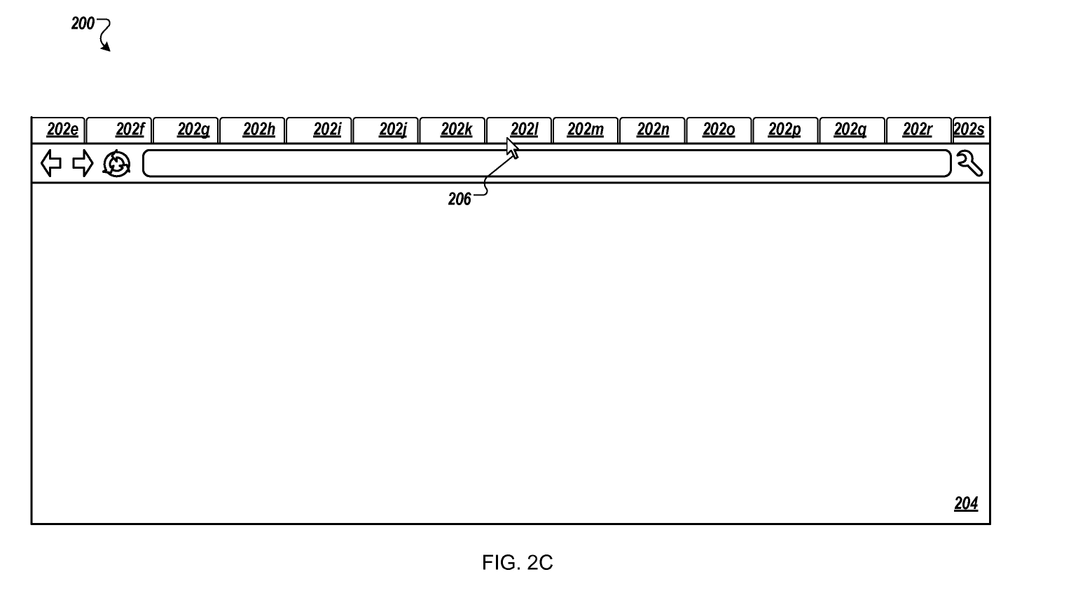

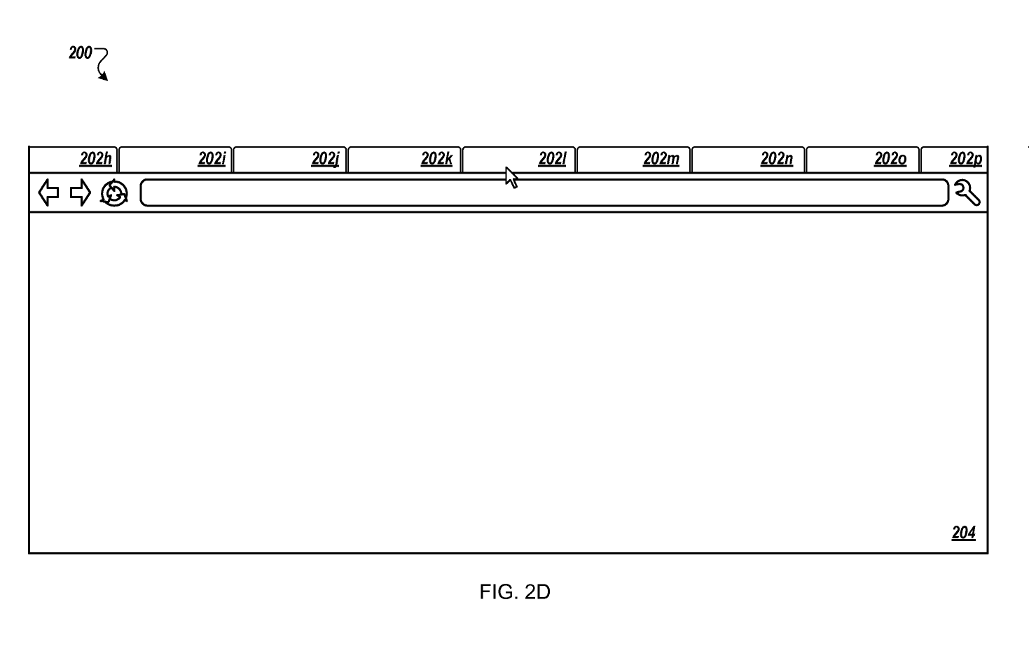

FIGS. 2A-D show examples of a graphical user interface for managing tabs in a graphical user interface using a mega lens style. FIG. 2A shows an example of a mega lens style GUI 200 in an initial state. The mega lens style GUI 200 includes multiple tabs 202a-w and a presentation area 204 for presenting content associated with a particular one of the tabs 202a-w. In some implementations, the mega lens style GUI 200 initially divides the amount of space available to the tabs 202a-w evenly among the tabs 202a-w, such as when the mega lens style GUI 200 is first initiated. In response to an input from a user that identifies a particular tab, such as the tab 202g, the mega lens style GUI 200 expands the tab 202g and one or more of the tabs surrounding the tab 202g that was identified. In some implementations, this results in the mega lens style GUI 200 no longer displaying tabs and/or portions of tabs that were previously at the ends of the set of tabs.

FIG. 2B shows an example of the mega lens style GUI 200 after receiving a first user input that identifies a tab for expansion. For example, the user can hover a pointer 206 over the tab 202g to identify the tab for expansion. The mega lens style GUI 200 expands the tab 202g substantially in place. For example, the center of the identified tab may remain the same before and after the expansion. In another example, the space occupied by the identified tab before and after the expansion may overlap. In some implementations, where the pointer 206 was used to select the tab 202g, the mega lens style GUI 200 expands the tab 202g so that the tab 202g remains under the position of the pointer 206 after the expansion.

The mega lens style GUI 200 also expands the tabs around the tab 202g that was identified by the user, such as the tabs 202c-f to the left of the identified tab and the tabs 202h-q to the right of the identified tab. In some implementations, the mega lens style GUI 200 expands the tab 202g and the surrounding tabs to a predetermined width, such as a particular number of pixels or a particular percentage of the space available in the tab bar. The mega lens style GUI 200 can, in some implementations, expand a particular number of tabs, such as about ten or fifteen tabs, and divide the space available among the particular number of tabs being expanded. In some implementations, the size of an expanded tab is based on the text or other information to be displayed in the tab. In some implementations, the number of tabs expanded to the left and to the right of the identified tab is determined by the amount of space available to the left and to the right, respectively.

The mega lens style GUI 200 returns the tabs 202c-q that were expanded to their original sizes as shown in FIG. 2A in response to the user no longer identifying a tab for expansion. The mega lens style GUI 200 also displays the tabs 202a-b and 202r-w again that were not displayed as a result of expanding the tabs 202c-q. For example, if the user moves the pointer 206 outside the area occupied by the tabs 202c-q, then the mega lens style GUI 200 resets all of the tabs 202a-w to the original non-expanded sizes.

FIG. 2C shows an example of the mega lens style GUI 200 after a second user input that identifies a second tab. For example, the user can move the pointer 206 back into the area occupied by the tabs 202a-w and, in particular, over the tab 202l. As a result, the mega lens style GUI 200 expands the tab 202l substantially in place and expands the tabs 202e-k and 202m-s around the tab 202l that was identified by the user input. This can result in a different set of tabs no longer being displayed at the ends of the tabs than in the example of FIG. 2B.

FIG. 2D shows an example of the mega lens style GUI 200 after a third user input that identifies a tab for further expansion. In response to a user input that requests a further expansion of the tab 202l, the mega lens style GUI 200 expands the tab 202l again as well as the tabs 202h-k and 202m-p that surround the tab 202l that was selected for further expansion. In some implementations, the user input that requests further expansion occurs for a threshold amount of time. The mega lens style GUI 200 then expands the tabs 202h-p again in response to receiving the user input that requests further expansion for the threshold amount of time. This further expansion can result in additional tabs no longer being displayed at the ends of the tabs 202e-s that were previously displayed. In some implementations, the mega lens style GUI 200 presents a partial representation of a tab at an end of the set of tabs in response to one or more tabs no longer being displayed at the end of the set of tabs. The partial tab can serve as an indication to the user that one or more additional tabs exist that the mega lens style GUI 200 is currently not displaying at that end of the set of tabs.

In some implementations, expansion of tabs can be based on a distance between a pointer and a tab bar in which the tabs are presented. For example, the pointer may be located within the presentation area 204. As the mega lens style GUI 200 receives a user input that moves the pointer 206 toward one or more of the tabs 202a-w, the mega lens style GUI 200 increases the amount by which the displayed ones of the tabs 202a-w are expanded. As the pointer 206 is moved away from the tabs, the mega lens style GUI 200 reduces the size of the tabs. An increase in expansion may result in one or more tabs at the periphery of the tab bar no longer being displayed and a decrease in expansion may result in one or more tabs at the periphery of the tab bar being displayed again.

The distance-based expansion may begin at a particular location from the tab bar. The particular location may be a fixed distance, such as a number of pixels or other measure of distance from the tab bar. The particular location may be a relative or proportional distance from the tab bar, such as a location that is halfway between the top and bottom of the presentation area.

The center of the distance-based expansion may be based on the position of the pointer in the direction that is tangent to the direction that is toward the tab bar. For example, as the mega lens style GUI 200 receives a user input that moves the pointer 206 horizontally across the presentation area 204, the mega lens style GUI 200 uses the horizontal position to determine the center of expansion of the tab 202a-w and accordingly which ones of the tabs 202a-w remain displayed in the tab bar after the expansion.

The mega lens style GUI 200 may match the horizontal position of the pointer 206 to the horizontal positions of the tabs 202a-w before any expansion, a shown in FIG. 2A, to identify a tab or position within the tabs 202a-w as the center of the expansion, referred to as the center tab. After expansion, the mega lens style GUI 200 may overlap at least a portion of the position of the expanded state of the center tab with the unexpanded state of the center tab. For example, the mega lens style GUI 200 may receive a user input where the pointer 206 is at a horizontal position in the presentation area 204 that is below the tab 202g. Accordingly, the mega lens style GUI 200 expands the tabs 202c-q as shown in FIG. 2B with the position of the tab 202g overlapping its position prior to the expansion. Alternatively, the mega lens style GUI 200 may place the center tab at the middle or center of the tab bar after the expansion.

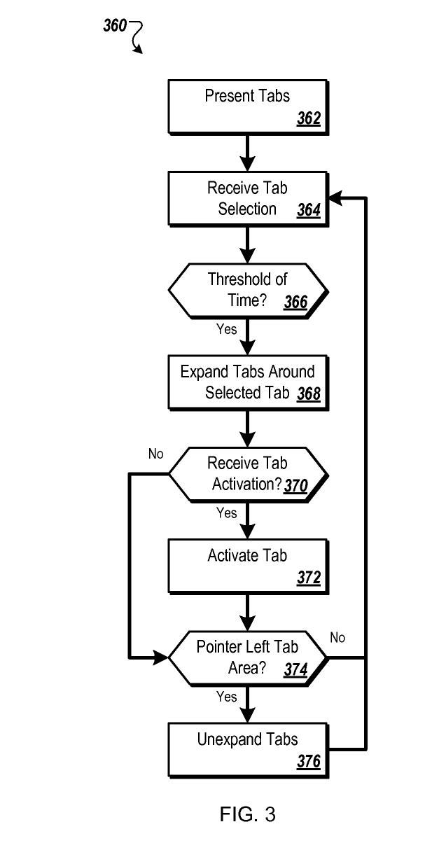

FIG. 3 is a flow chart that shows an example of a process 360 for managing tabs in a graphical user interface using a mega lens style. The process 360 may be performed, for example, by a system such as the system 100 and the mega lens style GUI 200. For clarity of presentation, the description that follows uses the system 100 and the mega lens style GUI 200 as examples for describing the process 360. However, another system, or combination of systems, may be used to perform the process 360.

The process 360 begins with presenting (362) a plurality of tabs in a tab area of a tabbed interface. The process 360 can include arranging the plurality of tabs horizontally in the tab area of the tabbed interface. In addition, the process 360 can include arranging the horizontally arranged plurality of tabs in an ordered list. For example, the computing device 102 can present the tabs 202a-w as a horizontally arranged ordered list in the mega lens style GUI 200 on the display device 104.

The process 360 receives (364) a user input that selects a tab from among the plurality of tabs. The plurality of tabs includes a subset of tabs around the selected tab and the subset of tabs includes fewer than all of the plurality of tabs. In some implementations, if the process 360 determines that the user input occurs for at least a threshold amount of time, then the process 360 expands the selected tab and the subset of tabs around the selected tab. In some implementations, the user input can include a hover operation of a pointer provided by a pointing device. For example, a user can operate a pointing device at the computing device 102 to hover the pointer 206 over a tab, such as the tab 202g, as shown in FIG. 2A.

The process 360 expands (368) a dimension of the selected tab and each of the subset of tabs in response to receiving the user input. For example, in response to hovering the pointer 206 over the tab 202g, the computing device 102 expands the tab 202g, the tabs 202c-f the left of the tab 202g, and the tabs 202h-q to the right of the tab 202g, as shown in FIG. 2B. In some implementations, the process 360 expands the dimension of the selected tab and each of the subset of tabs to encompass the tab area. For example, the computing device 102 expands the tabs 202c-q to encompass the tab area of the mega lens style GUI 200 and no longer presents the tabs 202a-b to the left of the expanded tabs and the tabs 202r-w to the right of the expanded tabs.

In some implementations, if the process 360 receives (370) a user input that activates a tab, then the process 360 activates (372) a panel associated with the tab in response to receiving the user input that activates the tab. The user input that activates the tab can be separate from and of a different type than the user input that selects a tab for expansion. For example, the computing device 102 can receive a hover operation with the pointer 206 to select the tab 202g and a click operation with the pointer 206 to activate a document associated with the tab 202g in the presentation area 204. In some implementations, the process 360 can receive a user input that both selects a tab for expansion and activates a document associated with the tab in a presentation area.

If the process 360 receives (374) a user input that moves the pointer (or other mode of user input that selects a tab for expansion) out of the tab area, then the process 360 returns (376) the dimension of each of the plurality of tabs to an unexpanded size in response to receiving the user input that moves the pointer out of the tab area. For example, the computing device 102 can receive an input that moves the pointer 206 off of the tab 202g and out of the tab area in the mega lens style GUI 200, as shown in FIG. 2B. In response, the computing device 102 can return each of the tabs 202a-w to an unexpanded size, as shown in FIG. 2A.

The process 360 can receive (364) another user input that selects another tab for expansion. In some implementations, if the process 360 determines that the pointer remains in the tab area between receiving a previous user input that selected a tab for expansion and receiving a subsequent user input that selects a subsequent tab for expansion, and if the process 360 determines that the subsequent user input occurs for at least a threshold amount of time (366), then the process 360 can expand the subsequently selected tab and the tabs around the subsequently selected tab again (368). For example, after expanding the tabs 202e-s, as shown in FIG. 2C, the computing device 102 can receive a subsequent user input that occurs for the threshold of amount of time (366). In response, the computing device 102 expands the tab 202l and the tabs around the tab 202l again, as shown in FIG. 2D.

Alternatively, the computing device 102 can receive a user input that moves the pointer 206 out of the tab area after selecting a previous tab for expansion, such as the tab 202g, as shown in FIG. 2B. In response, the computing device 102 can return each of the tabs 202a-w to an unexpanded size. The computing device 102 can then receive a subsequent selection of another tab, such as the tab 202l, and expands the subsequently selected tab and the tabs around the subsequently selected tab from the unexpanded size to a first expanded size, as shown in FIG. 2C.

After expanding one or more of the plurality of tabs, the process 360 can display at least a portion of the selected tab and each of the subset of tabs around the selected tab in the tab area of the tabbed interface. For example, the computing device 102 can expand the tabs 202c-q, the tabs 202e-s, or the tabs 202h-p so that at least a portion of each of the tabs is displayed in the tab area. In some implementations, the portion is less than the entire tab, such as the portions of the tabs 202c, 202q, 202e, 202s, 202h, and 202p at the ends of the sets of expanded tabs in FIGS. 2B-D. In some implementations, where a pointer is used to select the tab for expansion, at least a portion of the selected tab remains under a position of the pointer after expanding the dimension of the selected tab and each of the subset of tabs around the selected tab. In some implementations, the process 360 slides one or more of the tabs being expanded horizontally to accommodate expanding the dimension of the selected tab and each of the subset of tabs around the selected tab.

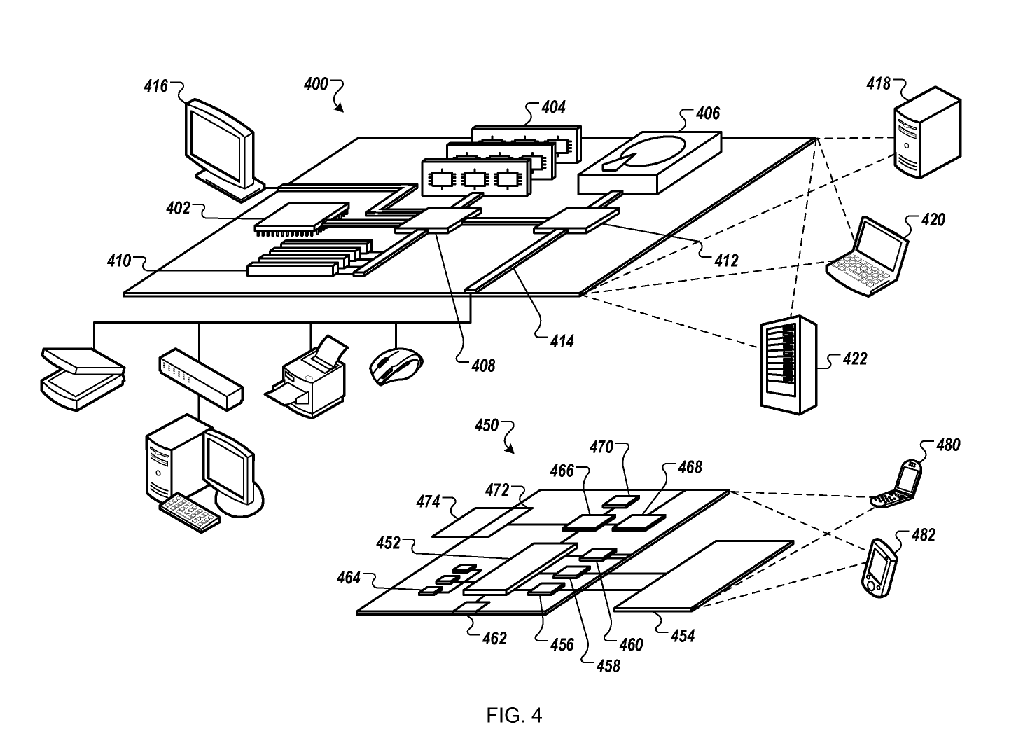

FIG. 4 is a schematic diagram that shows an example of a computing device 400 and an example of a mobile computing device that can be used to implement the systems and techniques described here. The computing device 400 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

The computing device 400 includes a processor 402, a memory 404, a storage device 406, a high-speed interface 408 connecting to the memory 404 and multiple high-speed expansion ports 410, and a low-speed interface 412 connecting to a low-speed expansion port 414 and the storage device 406. Each of the processor 402, the memory 404, the storage device 406, the high-speed interface 408, the high-speed expansion ports 410, and the low-speed interface 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as a display 416 coupled to the high-speed interface 408. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 404 stores information within the computing device 400. In some implementations, the memory 404 is a volatile memory unit or units. In some implementations, the memory 404 is a non-volatile memory unit or units. The memory 404 may also be another form of computer-readable medium, such as a magnetic or optical disk.

The storage device 406 is capable of providing mass storage for the computing device 400. In some implementations, the storage device 406 may be or contain a computer-readable medium, such as a floppy disk device, a hard disk device, an optical disk device, or a tape device, a flash memory or other similar solid state memory device, or an array of devices, including devices in a storage area network or other configurations.

A computer program product can be tangibly embodied in an information carrier. The computer program product may contain instructions that, when executed, perform one or more methods, such as those described above. The computer program product can also be tangibly embodied in a computer- or machine-readable medium, such as the memory 404, the storage device 406, or memory on the processor 402.

The high-speed interface 408 manages bandwidth-intensive operations for the computing device 400, while the low-speed interface 412 manages lower bandwidth-intensive operations. Such allocation of functions is exemplary only. In some implementations, the high-speed interface 408 is coupled to the memory 404, the display 416 (e.g., through a graphics processor or accelerator), and to the high-speed expansion ports 410, which may accept various expansion cards (not shown). In the implementation, the low-speed interface 412 is coupled to the storage device 406 and the low-speed expansion port 414. The low-speed expansion port 414, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 418, or multiple times in a group of such servers. In addition, it may be implemented in a personal computer such as a laptop computer 420. It may also be implemented as part of a rack server system 422. Alternatively, components from the computing device 400 may be combined with other components in a mobile device (not shown), such as a mobile computing device 450. Each of such devices may contain one or more of the computing device 400 and the mobile computing device 450, and an entire system may be made up of multiple computing devices communicating with each other.

The mobile computing device 450 includes a processor 452, a memory 464, an input/output device such as a display 454, a communication interface 466, and a transceiver 468, among other components. The mobile computing device 450 may also be provided with a storage device, such as a micro-drive or other device, to provide additional storage. Each of the processor 452, the memory 464, the display 454, the communication interface 466, and the transceiver 468, are interconnected using various buses, and several of the components may be mounted on a common motherboard or in other manners as appropriate.

The processor 452 can execute instructions within the mobile computing device 450, including instructions stored in the memory 464. The processor 452 may be implemented as a chipset of chips that include separate and multiple analog and digital processors. The processor 452 may provide, for example, for coordination of the other components of the mobile computing device 450, such as control of user interfaces, applications run by the mobile computing device 450, and wireless communication by the mobile computing device 450.

The processor 452 may communicate with a user through a control interface 458 and a display interface 456 coupled to the display 454. The display 454 may be, for example, a TFT (Thin-Film-Transistor Liquid Crystal Display) display or an OLED (Organic Light Emitting Diode) display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may provide communication with the processor 452, so as to enable near area communication of the mobile computing device 450 with other devices. The external interface 462 may provide, for example, for wired communication in some implementations, or for wireless communication in other implementations, and multiple interfaces may also be used.

The memory 464 stores information within the mobile computing device 450. The memory 464 can be implemented as one or more of a computer-readable medium or media, a volatile memory unit or units, or a non-volatile memory unit or units. The memory 464 may include, for example, flash memory and/or NVRAM memory (non-volatile random access memory).

An expansion memory 474 may also be provided and connected to the mobile computing device 450 through an expansion interface 472, which may include, for example, a SIMM (Single In-Line Memory Module) card interface. The expansion memory 474 may provide extra storage space for the mobile computing device 450, or may also store applications or other information for the mobile computing device 450. Specifically, the expansion memory 474 may include instructions to carry out or supplement the processes described above, and may include secure information also. Thus, for example, the expansion memory 474 may be provide as a security module for the mobile computing device 450, and may be programmed with instructions that permit secure use of the mobile computing device 450. In addition, secure applications may be provided via the SIMM cards, along with additional information, such as placing identifying information on the SIMM card in a secure manner.

In some implementations, a computer program product is tangibly embodied in an information carrier. The computer program product contains instructions that, when executed, perform one or more methods, such as those described above. The computer program product can be a computer- or machine-readable medium, such as the memory 464, the expansion memory 474, or memory on the processor 452. In some implementations, the computer program product can be received in a propagated signal, for example, over the transceiver 468 or the external interface 462.

The mobile computing device 450 may communicate wirelessly through the communication interface 466, which may include digital signal processing circuitry where necessary. The communication interface 466 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 468 using a radio-frequency. In addition, short-range communication may occur, such as using a Bluetooth, Wi-Fi, or other such transceiver (not shown). In addition, a GPS (Global Positioning System) receiver module 470 may provide additional navigation- and location-related wireless data to the mobile computing device 450, which may be used as appropriate by applications running on the mobile computing device 450.

The mobile computing device 450 may also communicate audibly using an audio codec 460, which may receive spoken information from a user and convert it to usable digital information. The audio codec 460 may likewise generate audible sound for a user, such as through a speaker, e.g., in a handset of the mobile computing device 450. Such sound may include sound from voice telephone calls, may include recorded sound (e.g., voice messages, music files, etc.) and may also include sound generated by applications operating on the mobile computing device 450.

The mobile computing device 450 may be implemented in a number of different forms, as shown in the figure. For example, it may be implemented as a cellular telephone 480. It may also be implemented as part of a smartphone 482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. For example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

1. A computer-implemented method for managing tabs in a graphical user interface, the method comprising:
receiving a first user input that selects a first tab from among a plurality of displayed tabs in a tab area of a tabbed interface;
expanding a dimension of the first tab and each of a first subset of tabs, from among and including fewer than all of the plurality of tabs, around the first tab in response to receiving the first user input;
causing one or more of the plurality of tabs to no longer be displayed based on the expansion of the dimension of the first tab and each of the first subset of tabs; and
providing a partial representation of a tab at an end of the plurality of displayed tabs in response to the one or more of the plurality of tabs no longer being displayed, wherein the partial representation of the tab indicates the one or more non-displayed tabs or provides for access to the one or more non-displayed tabs.

2. The method of claim 1, wherein expanding the dimension of the first tab and each of the first subset of tabs comprises expanding the first tab and the first subset of tabs to encompass the tab area.

3. The method of claim 1, wherein the first user input comprises a hover operation of a pointer provided by a pointing device.

4. The method of claim 3, wherein expanding comprises gradually expanding the dimension of the first tab and each of the first subset of tabs based on a distance between the first tab and the pointer.

5. The method of claim 3, wherein at least a portion of the first tab remains under a position of the pointer after expanding the dimension of the first tab.

6. The method of claim 3, further comprising:
receiving a second user input that selects a second tab from among the first tab and the first subset of tabs after receiving the first user input, wherein the pointer remains in the tab area between receiving the first user input and receiving the second user input, and wherein the second user input comprises the hover operation;
determining that the second user input occurs for at least a threshold amount of time; and
expanding the dimension of the second tab and each of a second subset of tabs, from among and including fewer than all of the first tab and the first subset of tabs, around the second tab again in response to determining that the second user input occurs for at least the threshold amount of time.

7. The method of claim 6, further comprising:
receiving a third user input that moves the pointer out of the tab area;
returning the dimension of each of the plurality of tabs to an unexpanded size in response to receiving the third user input;
receiving a fourth user input that selects a third tab from among the plurality of tabs after receiving the third user input, wherein the third user input comprises the hover operation; and
expanding the dimension of the third tab and each of a third subset of tabs, from among and including fewer than all of the plurality of tabs, around the third tab in response to receiving the third user input.

8. The method of claim 1, wherein at least a portion of the first tab and each of the first subset of tabs is displayed in the tab area after expanding the dimension of the first tab and each of the first subset of tabs.

9. The method of claim 1, wherein the plurality of tabs are arranged horizontally and wherein the method further comprises sliding one or more of the first tab and the first subset of tabs horizontally to accommodate expanding the dimension of the first tab and each of the first subset of tabs.

10. The method of claim 9, wherein the horizontally arranged plurality of tabs are further arranged in an ordered list; and wherein one or more of the first subset of tabs occur before the first tab in the ordered list and one or more of the first subset of tabs occur after the first tab in the ordered list.

11. The method of claim 1, further comprising:
receiving a fifth user input that activates the first tab, wherein the fifth user input is separate from and of a different type than the first user input; and
activating a panel associated with the first tab in response to receiving the fifth user input.

12. A computer-readable medium storing instructions that when executed cause a computer to perform operations for managing tabs in a graphical user interface, the operations comprising:
receiving a first user input that selects a first tab from among a plurality of displayed tabs in a tab area of a tabbed interface;
expanding a dimension of the first tab and each of a first subset of tabs, from among and including fewer than all of the plurality of tabs, around the first tab in response to receiving the first user input;
causing one or more of the plurality of tabs to no longer be displayed based on the expansion of the first tab and each of a first subset of tabs; and
providing a partial representation of a tab at an end of the plurality of displayed tabs in response to the one or more of the plurality of tabs no longer being displayed, wherein the partial representation of the tab indicates the one or more non-displayed tabs or provides for access to the one or more non-displayed tabs.

13. The computer-readable medium of claim 12, wherein expanding the dimension of the first tab and each of the first subset of tabs comprises expanding the first tab and the first subset of tabs to encompass the tab area.

14. The computer-readable medium of claim 12, wherein the first user input comprises a hover operation of a pointer provided by a pointing device.

15. The computer-readable medium of claim 14, wherein expanding comprises gradually expanding the dimension of the first tab and each of the first subset of tabs based on a distance between the first tab and the pointer.

16. The computer-readable medium of claim 14, wherein at least a portion of the first tab remains under a position of the pointer after expanding the dimension of the first tab.

17. The computer-readable medium of claim 14, wherein the operations further comprise:
receiving a second user input that selects a second tab from among the first tab and the first subset of tabs after receiving the first user input, wherein the pointer remains in the tab area between receiving the first user input and receiving the second user input, and wherein the second user input comprises the hover operation;
determining that the second user input occurs for at least a threshold amount of time; and
expanding the dimension of the second tab and each of a second subset of tabs, from among and including fewer than all of the first tab and the first subset of tabs, around the second tab again in response to determining that the second user input occurs for at least the threshold amount of time.

18. The computer-readable medium of claim 17, wherein the operations further comprise:
receiving a third user input that moves the pointer out of the tab area;
returning the dimension of each of the plurality of tabs to an unexpanded size in response to receiving the third user input;
receiving a fourth user input that selects a third tab from among the plurality of tabs after receiving the third user input, wherein the third user input comprises the hover operation; and
expanding the dimension of the third tab and each of a third subset of tabs, from among and including fewer than all of the plurality of tabs, around the third tab in response to receiving the third user input.

19. The computer-readable medium of claim 17, wherein at least a portion of the second tab and each of the second subset of tabs is displayed in the tab area after expanding the dimension of the second tab and each of the second subset of tabs.

20. The computer-readable medium of claim 17, wherein the plurality of tabs are arranged horizontally and wherein the operations further comprise sliding one or more of the second tab and the second subset of tabs horizontally to accommodate expanding the dimension of the second tab and each of the second subset of tabs.

21. The computer-readable medium of claim 20, wherein the horizontally arranged plurality of tabs are further arranged in an ordered list; and wherein one or more of the second subset of tabs occur before the second tab in the ordered list and one or more of the second subset of tabs occur after the second tab in the ordered list.

22. The computer-readable medium of claim 12, wherein the operations further comprise:
receiving a fifth user input that activates the first tab, wherein the fifth user input is separate from and of a different type than the first user input; and
activating a panel associated with the first tab in response to receiving the fifth user input.

23. A computer-implemented system for managing tabs in a graphical user interface, the system comprising:
a display device that presents a plurality of tabs in a tab area of a tabbed interface;
an interface that receives a first user input that selects a first tab from among the plurality of displayed tabs;
one or more processors that expand a dimension of the first tab and each of a first subset of tabs, from among and including fewer than all of the plurality of tabs, around the first tab in response to receiving the first user input; that cause one or more of the plurality of tabs to no longer be displayed based on the expansion of the first tab and each of a first subset of tabs; and that provide a partial representation of a tab at an end of the plurality of displayed tabs in response to the one or more of the plurality of tabs no longer being displayed, wherein the partial representation of the tab indicates the one or more non-displayed tabs or provides for access to the one or more non-displayed tabs.
